(19) United States
(12) Patent Application Publication
(10) Pub. No.: US 2006/0164924 A1
(43) Pub. Date: Jul. 27, 2006

(54) Timepiece movement holding structure and timepiece

(75) Inventors: Hiroyuki Arai, Matsumoto-shi (JP); Takumi Ooshio, Kowloon (HK)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/339,497

(22) Filed: Jan. 26, 2006

(30) Foreign Application Priority Data
Jan. 26, 2005 (JP) JP2005-017925
Nov. 1, 2005 (JP) JP2005-317999

(51) Int. Cl. G04B 37/00; A44C 5/00

(52) U.S. Cl. 368/281

(57) ABSTRACT

It is an object of the present invention to provide a timepiece movement holding structure and a timepiece which make it possible to realize a design that is elongated in the longitudinal direction or the lateral direction. The timepiece movement holding structure comprises a first casing frame which holds the end part of the movement in the 6 o'clock direction, and a second casing frame which holds the end part of the movement in the 12 o'clock direction. The widths of the first casing frame and second casing frame in the 3 o'clock to 9 o'clock direction are set substantially the same as the width of the movement in the 3 o'clock to 9 o'clock direction. These casing frames and are disposed substantially within the width of the movement in the 3 o'clock to 9 o'clock direction, and the movement is held in the plane direction between the interior-forming case body portions through of the case body and the first casing frame and second casing frame . The movement is held in the sectional direction between the case body and back cover as a result of the first casing frame and second casing frame being pressed in the sectional direction of the movement by an inside main surface or back cover fixing parts provided to the back cover.

### TECHNICAL FIELD

The present invention relates to a timepiece movement holding structure, and more particularly relates to a timepiece movement holding structure which allows a design in which the width of the timepiece in the 3 o'clock to 9 o'clock direction or the 6 o'clock to 12 o'clock direction is reduced, and to a timepiece.

### RELATED ART

In the prior art, there are structures referred to as timepiece movement holding structures. In these structures, a movement is fixed to a timepiece case by means of a casing frame consisting of a synthetic resin, wherein this casing frame is integrally formed around the entire circumference of the end part of the movement in the plane direction. A flange part that extends in flange form is provided together with the outer circumferential part around the entire circumference. A movement engaging part used to hold the movement in the vertical direction, and a spring part that extends downward are further formed, a space part which acts to alleviate shocks caused by external forces applied to the casing frame is disposed in the spring part, and the movement is held by the elastic force of this spring part (for example, see Patent Reference 1).

Japanese Utility Model Application No. 6-86094 (page 5, FIGS. 1 and 6) is hereby incorporated by reference.

### SUMMARY

[Problems to be Solved by the Invention]

In this Patent Reference 1, a casing frame that is provided in order to hold the movement is formed around the entire circumference of the movement. Accordingly, in order to realize a small external shape of the case, the size of the case must be increased by an amount equal to that portion of the case occupied by the flange part of the casing frame. In particular, a design in which the width in the 3 o'clock to 9 o'clock direction is smaller than the length in the 6 o'clock to 12 o'clock direction cannot be realized.

Furthermore, even with a back cover in which the movement is accommodated in a case, and an elastic force is applied to the casing frame, the back cover fixing part that protrudes from the inside main surface of the back cover is generally formed on the outside of the entire circumference of the casing frame, that is, along the entire circumference, and since this back cover fixing part is present, it is believed that an elongated timepiece design such as the one described above is difficult to realize.

It is an object of the present invention to provide a timepiece movement holding structure and timepiece which make it possible to solve the problems, and to realize a design that is elongated in the longitudinal direction, in which the width in the 3 o'clock to 9 o'clock direction is smaller, or a design that is elongated in the lateral direction, in which the width in the 12 o'clock to 6 o'clock direction is smaller.

[Means used to Solve the above-Mentioned Problems]

The timepiece movement holding structure of the present invention is a timepiece movement holding structure which uses a casing frame to hold a movement between the case body and back cover of a timepiece case, comprising a first casing frame which holds the end portion of the movement in a first direction, and a second casing frame which holds the end portion of the movement in the opposite direction from the first direction, wherein the first casing frame and the second casing frame are respectively disposed on the outside of the end portion of the movement in the first direction, and substantially within the width of the movement in the second direction, and hold the movement.

Here, for example, the 6 o'clock to 12 o'clock direction of the timepiece is expressed as the first direction, and the 3 o'clock to 9 o'clock direction is expressed as the second direction. In the present invention, the casing frame used to hold the movement is separated into a first casing frame and a second casing frame, and these first and second casing frames are disposed within the width of the movement (i.e., the width in the 3 o'clock to 9 o'clock direction or the 6o'clock to 12 o'clock direction). Accordingly, there is no connecting part connecting the first casing frame and second casing frame on either side of the movement in the 3 o'clock to 9 o'clock direction, or on either side in the 6 o'clock to 12 o'clock direction. Consequently, the width of the timepiece in the 3 o'clock to 9 o'clock direction or in the 6 o'clock to 12 o'clock direction can be reduced, so that a timepiece with a smart design that is elongated in the longitudinal direction or the lateral direction can be provided.

Furthermore, in the structure of the present invention, it is preferable that the respective widths of the first casing frame and the second casing frame in a second direction that is perpendicular to the first direction be set so that these widths are substantially the same as the width of the movement in the second direction, that the movement be held in the plane direction between the internal shape parts of the case body, and the first casing frame and the second casing frame, and that the movement be held in the sectional direction between the case body and the back cover as a result of the first casing frame and the second casing frame being pressed in the sectional direction of the movement by an inside main surface or a back cover fixing part disposed on said back cover.

In this construction, since the first casing frame and second casing frame respectively hold the movement in the plane direction and the sectional direction, the movement can be securely held even in the case of a structure that is separated into a first casing frame and second casing frame. Accordingly, the movement can be securely protected against impact forces from the outside of the timepiece.

Furthermore, the structure of the present invention preferably comprises rotation-stopping parts which are formed on either the plane surfaces or end surfaces of the end portions of the movement in the first direction and in the opposite direction from the first direction, and rotation-stopping parts which are formed on either the first casing frame or the second casing frame in positions corresponding to the rotation-stopping parts formed on the movement, wherein the rotation of the movement in the plane direction is restricted.

Here, for example, recessed parts can be formed on the movement side as rotation-stopping parts, or protruding parts can be formed on the first and second casing frames as such parts.

Even in a structure that is separated into a first casing frame and a second casing frame as described above, since rotation-stopping parts are provided for the movement, rotation of the movement in the plane direction can be prevented in a compact movement with an extended longitudinal dimension in which the width in the 3 o'clock to 9 o'clock direction is smaller than the length in the 6 o'clock to 12 o'clock direction, or in a compact movement with an extended lateral dimension in which the width in the 6 o'clock to 12 o'clock direction is smaller than the length in the 3 o'clock to 9 o'clock direction, or in a compact movement that has a circular shape. Accordingly, a design that has a reduced width in the 3 o'clock to 9 o'clock direction or in the 6 o'clock to 12 o'clock direction can be realized, and the movement can be securely held.

Furthermore, in the structure of the present invention, it is preferable that the first casing frame and second casing frame have movement-restricting parts for the movement that restrict the movement of the movement with respect to the casing frames in at least one direction selected from the first direction and the second direction by contacting the outside surface of the movement within the width of the movement in the second direction. In this construction, looseness of the movement with respect to the first casing frame and second casing frame can be securely prevented by the movement-restricting parts for the movement [mechanism].

In this case, it is preferable that the first casing frame and second casing frame have protruding parts which are disposed in the vicinity of the restricting parts, and which contact the interior-forming portion of the case body, and that these protruding parts contact the wall surfaces of the interior-forming portion of the case body so that the movement of these casing frames with respect to the case body is restricted. In this construction, since the movement of the first casing frame and second casing frame with respect to the case body is restricted by the protruding parts in the vicinity of the movement, looseness of the respective casing frames can be securely prevented, and looseness of the movement can be even more securely prevented.

Furthermore, in the structure of the present invention, it is preferable that the width of the back cover fixing part of the back cover in the second direction be set at substantially the same width as the width of the movement in the second direction as a result of a portion of this back cover fixing part being removed.

In such a construction, the back cover fixing part is formed in only one direction of the timepiece, and is removed on the side of the second direction. Accordingly, compared to the prior art in which a back cover fixing part is formed around the entire circumference of the movement, the width of the timepiece in the first direction can be reduced. Furthermore, it is preferable that the widths of the first casing frame and second casing frame in the second direction and the width of the back cover fixing part in this second direction be set at substantially the same width as the width of the movement in this second direction.

In this case, the first casing frame, second casing frame, and back cover fixing part formed on the back cover are set at substantially the same width as the width of the movement in the second direction, providing a timepiece with a smart design having an extended longitudinal dimension and a reduced width in the second direction.

Furthermore, the timepiece of the present invention has timepiece movement holding structure. This invention makes it possible to provide a timepiece having a smart design that is extended in the longitudinal or lateral direction.

### BRIEF DESCRIPTION OF THE DRAWINGS

FIG. 1 is a perspective view showing the external appearance of the timepiece of the present invention.

FIG. 2 is an exploded perspective view of the timepiece body in Embodiment 1 of the present invention.

FIG. 3 is an enlarged perspective view of the movement, first casing frame, second casing frame, and back cover.

FIG. 4 is a plan view showing the structure of the timepiece body.

FIG. 5(a) is a local sectional view showing the timepiece movement holding structure, and FIG. 5(b) is a local sectional view showing the movement fixing parts of the first casing frame as seen from the direction indicated by the arrow A in FIG. 4.

FIG. 6 is a local sectional view showing the structure of the timepiece body in the 3 o'clock direction.

FIG. 7 shows an example of comparison of the timepiece of the present invention and a conventional timepiece.

FIG. 8 is a local sectional view showing the timepiece movement holding structure of Embodiment 2 of the present invention.

FIG. 9 is a local sectional view showing the timepiece movement holding structure of Embodiment 3 of the present invention.

### PREFERRED EMBODIMENTS

Embodiments of the present invention will be described hereinafter with reference to the drawings. As is clear from the disclosure of the present invention to one skilled in the art, the description relating to working examples of the present invention is given only for the purpose of describing the present invention, and shall not be construed as limiting the present invention as defined within the scope of the claims described hereinafter, or within an equivalent range.

Embodiments of the present invention will be described below with reference to the attached figures.

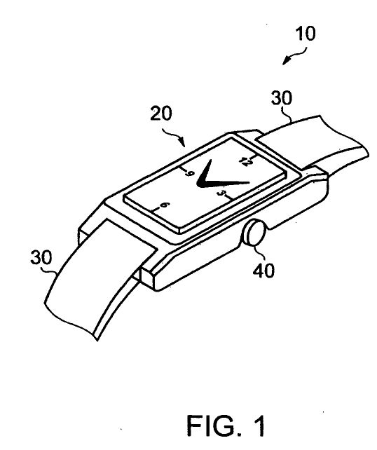

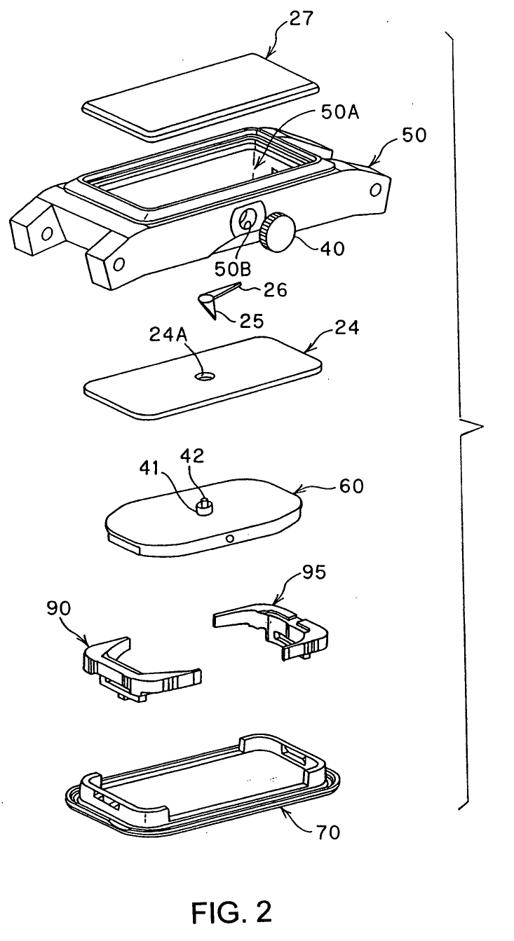

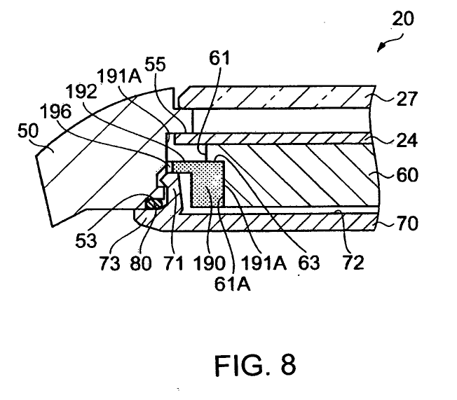

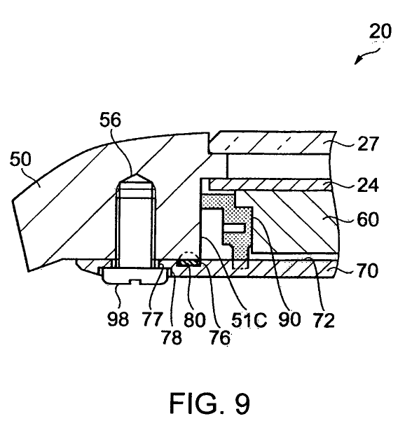

FIG. 1 is a perspective view showing the external appearance of the timepiece of the present invention. FIGS. 2 through 7 show the timepiece movement holding structure of Embodiment 1 of the present invention. FIG. 8 shows the movement holding structure of Embodiment 2, and FIG. 9 shows the movement holding structure of Embodiment 3.

### Embodiment 1

In FIG. 1, the timepiece 10 of the present invention is constructed from a timepiece body 20 in which a time display part and a movement having front and back face are accommodated inside a case, and a band 30 which is used to mount the timepiece body 20 on the arm. Furthermore, the timepiece further comprises a crown 40 which is used to adjust the time.

In the case of this timepiece 10, an elongated design in which the width in the 3 o'clock to 9 o'clock direction taken as the first direction (sandwiched direction) is smaller than the length l the 12 o'clock to 6 o'clock direction taken as the second direction is shown as an example. For example, this has been adopted as a popular design for compact ladies' timepieces.

Next, a structure used to realize a timepiece of the present invention having an elongated design will be described with reference to FIGS. 2 through 4.

FIG. 2 shows an exploded perspective view of the timepiece body 20. This timepiece body 20 has a case body 50 that forms a timepiece case. A substantially rectangular opening part that passes through in the vertical direction is formed in this case body 50. A dial 24 and a movement 60 are disposed in a stacked configuration in the opening part 50A of this case body 50. Furthermore, a first casing frame 90 and a second casing frame 95 are disposed around the movement 60, and the back side is closed off by a back cover 70, while the front side is closed off by a protective glass 27. Furthermore, the movement 60 has an hour wheel 41 and a center wheel and pinion 42 that are driven by an internal driving mechanism. The respective wheels 41 and 42 extend above the dial 24 through a center hole 24A formed in the dial 24. An hour hand (pointer) 25 is attached to the hour wheel 41, a minute hand (pointer) 26 is attached to the center wheel and pinion 42, and the time is indicated by these time indicating hands 25 and 26. Furthermore, the crown 40 is passed through a through-hole 50B formed in the case body 50, and is connected to the winding stem (not shown in the figures) of the movement 60.

Furthermore, in the present embodiment, a timepiece 10 having an hour hand 25 and minute hand 26 is shown as an example; however, the present invention can also be widely applied to timepieces that have other display hands such as a second hand, a 24-hour hand or the like, or that perform a calendar display, display of phases of the moon, or the like.

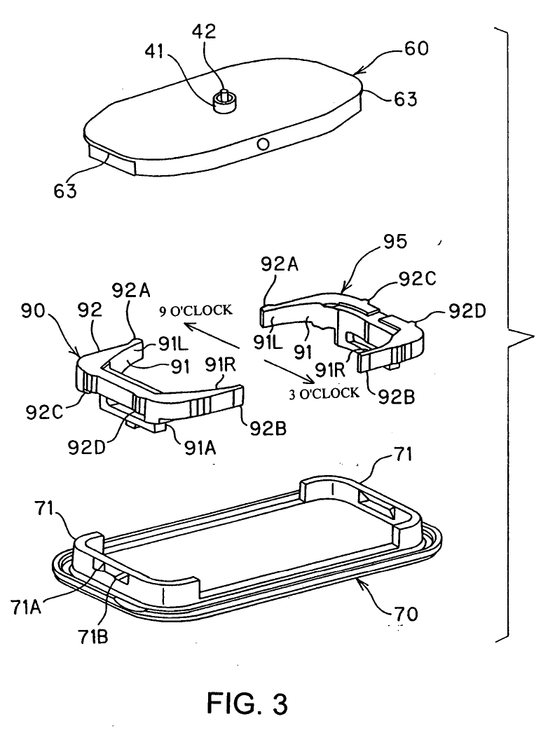

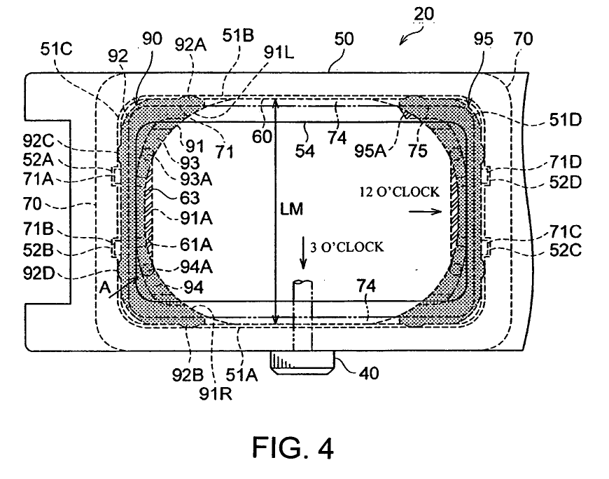

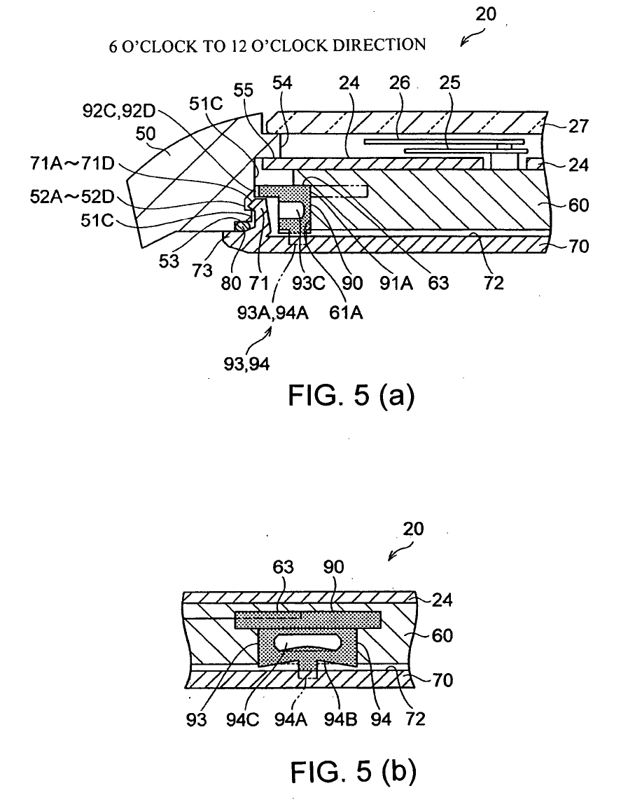

FIG. 3 is an enlarged perspective view of the movement 60, a first casing frame 90, a second casing frame 95, and a back cover 70. FIG. 4 shows a state in which the timepiece body 20 is viewed from the direction of the time indicating part, and FIG. 5(a) shows a sectional view of the timepiece body 20 in the 6 o'clock to 12 o'clock direction. Furthermore, in FIG. 4, a state is shown in which the protective glass 27, hour hand 25, minute hand 26, and dial 24 are removed in order to facilitate the description.

As is shown in FIG. 4, the case body 50 has an elongated shape in which the length in the 12 o'clock to 6 o'clock direction is longer than the width in the 3 o'clock to 9 o'clock direction. As is shown I FIG. 5(a), a return surface 54 that regulates the time display surface of the dial 24, a dial receiving part 55 that is used to hold the dial 24, and interior-forming case body portions 51A through 51D that restrict the movement of the movement 60 in the plane direction are formed inside.

As is shown in FIG. 4, the interior-forming case body portion 51A is installed in order to adjust the position in the 3 o'clock direction, 51B is installed in order to adjust the position in the 9 o'clock direction, 51C is installed in order to adjust the position in the 6 o'clock direction, and 51D is installed in order to adjust the position in the 12 o'clock direction, A substantially rectangular space (the opening part 50A) is formed by the interior-forming case body portions 51A to 51D, and the longitudinally oblong movement is accommodated in this space.

Recessed parts in two locations of back cover fixing grooves (concave portions) 52A and 52B that are used to fix the back cover 70 to the case body 50 are formed in the interior-forming case body portion 51C, and recessed parts in two locations of back cover fixing grooves (concave portions) 52C and 52D are formed in positions facing the back cover fixing grooves 52A and 52B in the interior-forming case body portion 51D that faces the interior-forming case body portion 51C.

As is shown in FIG. 4, the movement 60 has a substantially oval shape that is elongated in the longitudinal direction, in which the width gradually decreases moving in the 6o'clock direction and 12 o'clock direction from the center. A first casing frame 90 is disposed on the 6 o'clock side of this movement 60, and a second casing frame 95 is disposed on the 12 o'clock side of the movement 60. These casing frames 90 and 95 are formed with a substantially recessed shape (C shape) so as to envelop both sides (the 6 o'clock side and 12 o'clock side) of the movement 60.

Here, in the following description, the first casing frame 90 and second casing frame 95 have substantially symmetrical shapes with respect to a line connecting 3 o'clock and 9 o'clock. Therefore, the first casing frame 90 on the 6 o'clock side will be described in detail, and a description of the second casing frame 95 will be omitted. As is shown in FIGS. 3 and 4, the first casing frame 90 has a substantially horseshoe shape (recessed shape) surrounded by a movement guide (movement-restricting part for the movement [mechanism]) 91 that contacts the end surface (outside surface) of the movement 60 in the 6 o'clock direction and the outside part 92 on the side of the case body 50, and is formed by injection-molding an elastic synthetic resin.

More concretely, the movement guide 91 contacts the end surface (outside surface) of the movement 60 in the range extending substantially from the 4 o'clock position to the 8 o'clock position, with the 6 o'clock position of the movement 60 sandwiched therebetween. In other words, this movement guide 91 contacts the entire end surface on the 6 o'clock side within the width (maximum width) LM of the movement 60. As a result, the movement 60 is sandwiched in substantially the 3 o'clock to 9 o'clock direction by the two end parts 91L and 91R of the movement guide 91, so that movement (i.e., looseness) of the movement 60 with respect to the first casing frame 90 in the 3 o'clock to 9 o'clock direction and 6 o'clock direction is restricted.

Furthermore, a movement rotation stopper 91A in contact with a stepped movement fixing part 61A (see FIG. 5) formed in the end portion of the movement 60 in the 6 o'clock direction is formed on the movement guide 91. This stepped movement fixing part 61A is formed by a straight line parallel to a straight line connecting 3 o'clock and 9 o'clock in the end portion of the movement 60 in the 6 o'clock direction. Thus, as a result of the movement rotation stopper 91A contacting the movement guide 91 in this rectilinear movement fixing part 61A, movement of the movement 60 in the 6 o'clock direction with respect to the first casing frame 90 is more restricted, and the movement 60 is impeded in its rotation with respect to the first casing frame 90.

The plane surface that is formed toward the outer circumference from this movement fixing part 61A is a movement fixing surface 63 (see FIGS. 3 and 4). A similar movement fixing part and movement fixing surface 63 are also formed in the end portion of the movement 60 in the 12 o'clock direction (indicated by hatching in FIG. 4).

Furthermore, protrusions 92C and 92D that are caused to protrude toward the outer circumference on the 6 o'clock side, a protrusion 92A that is caused to protrude on the 9 o'clock side, and a protrusion 92B that is caused to protrude on the 3 o'clock side, are formed on the externally shaped part 92 that is caused to protrude as a flange from the circumferential edge of the first casing frame 90. Here, these protrusions (protruding parts) 92A and 92B are disposed on thin parts in the 9 o'clock direction and 3 o'clock direction of the first casing frame 90, and the protrusions (protruding parts) 92C and 92D are disposed (with a gap left between these parts) in a thin portion in the 6 o'clock direction of the first casing frame 90. As a result, these parts are disposed on the back-surface side of the movement guide 91 of the first casing frame 90, in positions located in the vicinity of the movement guide 91. Protrusions corresponding to these protrusions 92A through 92D are also formed on the second casing frame 95.

These protrusions 92A through 92D are dimensionally set so that when the these protrusions are incorporated so as to sandwich the movement 60 between the first casing frame 90 and second casing frame 95, there is room for tightening between these parts and the interior-forming case body portions 51A through 51D on the side of the case body 50. The protrusions have the function of holding the movement 60 so that the movement 60 does not move in the plane direction.

Furthermore, in the present embodiment, as is shown in FIG. 4, a groove-shaped movement rotation stopper 95A is formed in the second casing frame 95. A movement rotation stopper is also formed on the movement 60 in a position and with a shape corresponding to those of the movement rotation stopper 95A, so that prevention of the rotation of the movement 60 is made even more secure.

Furthermore, this movement rotation stopper 95A can also be formed in the first casing frame 90 or in both casing frames. Moreover, when the first casing frame 90 and second casing frame 95 are formed with asymmetrical shapes, mistakes in the assembly of the casing frames 90 and 95 can be prevented by using differently colored parts for the first casing frame 90 and second casing frame 95, so that assembly work is facilitated.

Furthermore, the movement rotation stopper 95A can be provided with a rotation-stopping recessed part on the surface of the movement 60 on the back side of the case, and may be shaped to allow mounting on the movement surface in accordance with this shape. Moreover, a cut-out recessed part may be formed in the end surface of the movement, and the movement rotation stopper may be formed with a shape corresponding to this recessed part.

Furthermore, movement fixing parts (elastic deforming parts) 93 and 94 that protrude toward the back cover 70 are formed in the sectional direction in the first casing frame 90 in two locations along the movement guide 91. As is shown in FIGS. 5(a) and 5(b), contact portions 93A and 94A are formed in the respective centers of these movement fixing parts 93 and 94, and these contact portions 93A and 94A are [devised so that] the movement fixing surface 63 of the movement 60 is pressed toward the dial receiving part 55 of the case body 50 by the inside main surface 72 of the back cover 70, thus restricting the position in the sectional direction and holding the movement 60.

Furthermore, in both the first casing frame 90 and second casing frame 95, the width in the 3 o'clock to 9 o'clock direction is set at a width that is smaller than the width of the movement 60 in the 3 o'clock to 9 o'clock direction, excluding the protrusions 92A and 92B (no reference numerals are assigned to the second casing frame 95), so that these casing frames do not protrude beyond the external shape of the movement 60.

The back cover 70 has a substantially rectangular shape in which the width of the external shape in the 3 o'clock to 9 o'clock direction is slightly smaller than the width of the case body 50. The back cover 70 is formed from a metal such as stainless steel or the like. As is shown in FIG. 3, back cover fixing parts 71 that are caused to protrude in the sectional direction are formed on the 6 o'clock side and 12 o'clock side of the back cover 70, and these back cover fixing parts 71 are omitted on the 3 o'clock side and 9 o'clock side. Back cover fixing projections 71A through 71D are formed on these back cover fixing parts 71 in positions corresponding to the back cover fixing grooves 52A through 52D formed in the case body 50, so that the back cover 70 is fixed to the case body 50.

Next, the holding structure and holding method of the movement 60 will be described in detail with reference to FIG. 5. The timepiece body 20 is substantially symmetrical with respect to a straight line connecting 3 o'clock and 9 o'clock on the timepiece; accordingly, the 6 o'clock side will be described as an example.

FIG. 5(b) is a local sectional view showing the movement fixing part 94 of the first casing frame 90 as seen from the direction indicated by the arrow A in FIG. 4. In FIGS. 5(a) and 5(b), the movement 60 is mounted inside the case body 50 in the mounted state of the dial 24. In this state, the movement 60 can move inside the case body 50 along with the dial 24.

Next, the first casing frame 90 and second casing frame 95 are mounted. The movement guide 91 of the first casing frame 90 is mounted so as to contact the movement fixing part 61A of the movement 60. In this case, since the protrusions 92A through 92D are set so that there is room for tightening between these parts and the interior-forming case body portion 51C of the case body 50, these protruding parts are flattened so that the movement of the movement 60 in the plane direction is restricted.

Furthermore, movement fixing parts 93 and 94 that protrude in the sectional direction are formed on the first casing frame 90, and contact portions 93A and 94A are formed on the upper surfaces (indicated as undersurfaces in the figures) of the movement fixing parts. When the back cover 70 is mounted on the case body 50, pressure is applied so that the movement fixing surface 63 of the movement 60 is pressed, and the movement 60 is fixed against the dial receiving part 55 of the case body 50 via the dial 24.

A back cover fixing part 71 is caused to protrude from the back cover 70, and back cover fixing projections 71A through 71D are formed on this back cover fixing part 71. Since these back cover fixing projections 71A through 71D are caused to protrude further to the outside than the interior-forming case body portion 51C, the back cover fixing part 71 flexes to the inside when the back cover 70 is mounted on the case body 50, and when the back cover fixing part reaches the back cover fixing grooves 52A through 52D, the back cover fixing projections 71A through 71D enter the back cover fixing grooves 52A through 52D, so that the back cover 70 is fixed to the case body 50.

A gasket-mounting groove 53 is formed around the entire circumference of the case body 50 in the surface along which the outer circumference of the case body 50 and the back cover 70 are joined together, and a gasket 80 is mounted in this gasket-mounting groove 53. A flanged back cover circumferential edge 73 is formed on the outer circumference of the back cover 70, and this component presses against the gasket 80 when the back cover 70 is mounted. As a result, the movement of the back cover 70 in the sectional direction is restricted, and the waterproof properties of the timepiece body 20 are ensured by the gasket 80.

Furthermore, a gasket-mounting groove can be formed in the back cover 70. In cases where a gasket-mounting groove is formed in the back cover 70, the thickness of the case body 50 can be reduced to the extent that it is not necessary to form a gasket groove in the case body 50, so that the timepiece 10 can be made thinner.

The structure of the movement fixing part 94 of the first casing frame 90 will be described in greater detail with reference to FIG. 5(b). In FIG. 5(b), a contact portion 94A is formed in the upper surface (undersurface in the figures) of the movement fixing part 94 formed on the first casing frame 90. Furthermore, a shock-absorbing hole 94C is formed in an intermediate part. When the back cover 70 is mounted on the case body 50, the contact portion 94A is pressed by the inside main surface 72 of the back cover 70 (i.e., is moved from the position indicated by a two-dot chain line in the figures to the position indicated by a solid line), so that the shock-absorbing hole 94C is deformed. As a result of the deformation of this shock-absorbing hole 94C, the movement 60 is fixed by the elasticity of the movement fixing part 94. In this case, the stepped portion 94B formed by the contact portion 94A is set so that this portion does not contact the back cover 70.

The movement fixing part 94 is made of an elastic material, and the stepped portion 94B is formed in the shape of a bridge. Accordingly, the first casing frame 90 can perform the movement-fixing function even if the back cover 70 is repeatedly attached and removed. A casing frame that fixes the movement by using the elasticity of the casing frame in this manner is called a spring casing frame.

Next, the structure of the timepiece body 20 of the present embodiment in the 3 o'clock to 9 o'clock direction will be described with reference to the figures.

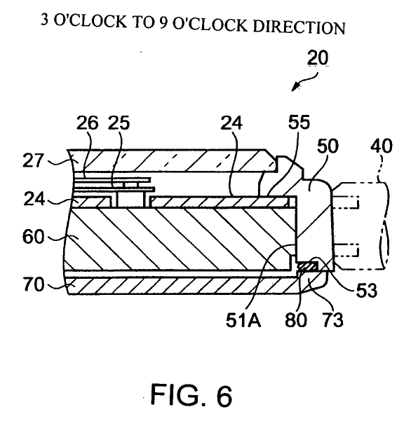

FIG. 6 is a local sectional view showing the structure of the timepiece body of the present embodiment in the 3 o'clock direction. Since the 9 o'clock direction has the same structure as the 3 o'clock direction, a description of this structure is omitted. This structure will be described using the same reference numerals as in FIGS. 4 and 5. In FIG. 6, the first casing frame 90 and second casing frame 95 disposed in the 12 o'clock to 6 o'clock direction shown in FIGS. 4 and 5 are absent in the 3 o'clock direction of the timepiece body 20. Furthermore, there are likewise no back cover fixing grooves 51A through 52D formed in the back cover 70.

Accordingly, in the 3 o'clock direction of the timepiece body, the interior-forming case body portion 51A (see FIG. 4) on the 3 o'clock side can be disposed in a position contacting the movement 60. Specifically, the width of the timepiece body 20 in the 3 o'clock to 9 o'clock direction may be the dimension that is obtained by adding the width of the case body 50 to the width of the movement 60 in the 3 o'clock to 9 o'clock direction. The same relationship also holds true for the 9 o'clock direction.

Furthermore, a winding stem not shown in the figures is fixed to the crown 40 so that the time can be adjusted, but since this is a universally known structure, a description is omitted.

In the 3 o'clock and 9 o'clock directions as well, a gasket-mounting groove 53 is formed in the case body 50 as a continuation from the 12 o'clock to 6 o'clock direction, and a gasket 80 is mounted and is pressed by the back cover circumferential edge 73.

Accordingly, in the Embodiment 1, the casing frame that is used to hold the movement 60 is separated into a first casing frame 90 and second casing frame 95, and the casing frames 90 and 95 are respectively disposed within the width LM of the movement 60 on both sides of the movement 60 in the 3 o'clock to 9 o'clock direction (see FIG. 4). Accordingly, there are no connecting parts that connect the first casing frame 90 and second casing frame 95 on both sides of the movement 60 in the 3 o'clock to 9 o'clock direction. Consequently, compared to a conventional timepiece in which a casing frame is installed around the entire circumference of the movement, the width in the 3 o'clock to 9 o'clock direction can be reduced, and a timepiece 10 with a longitudinally oblong smart design can be provided. Furthermore, within the range in which the desired value can be obtained as the width dimension of the timepiece 10, the casing frames 90 and 95 may also be positioned outside the width of the movement 60. In short, the positions of the casing frames 90 and 95 are mainly within the width of the movement 60, but may also include positions outside this width.

Furthermore, the portions in the 3 o'clock and 9 o'clock directions are removed (indicated by the two-dot chain line and reference numeral 74 in the figures) in the back cover fixing part 71 of the back cover 70. Therefore, the width of the timepiece in the 3 o'clock to 9 o'clock direction can be reduced compared to the prior art in which a movement fixing part is formed around the entire circumference of the movement.

As a result of such a structure, the interior-forming case body portions 51A and 51B in the 3 o'clock direction and the 9 o'clock direction can be caused to approach positions that contact the end parts of the movement 60, so that even if a special movement with a reduced width is developed, a timepiece with a longitudinally oblong smart design with a reduced width in the 3 o'clock to 9 o'clock direction can be provided.

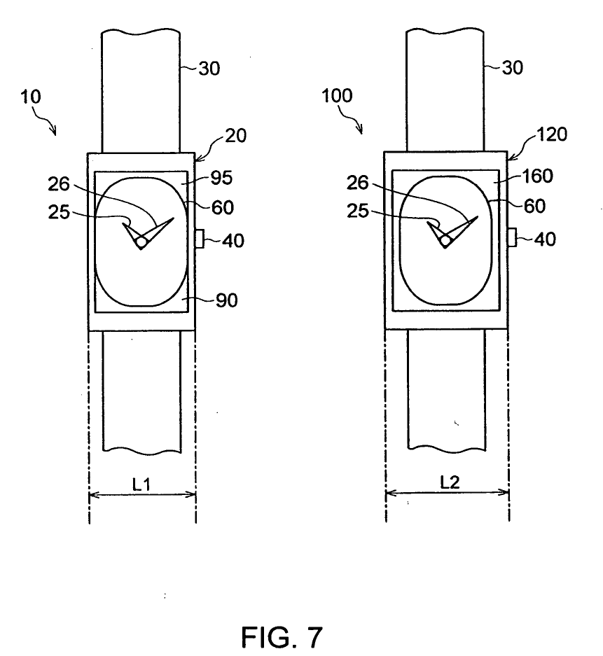

FIG. 7 shows an example comparing the timepiece 10 of the present embodiment and a conventional timepiece 100. Furthermore, in this figure, the timepieces are shown with the dials omitted for convenience of description; moreover, substantially similar constituent elements are labeled with the same reference numerals. Furthermore, in the conventional timepiece 100, the timepiece body is indicated by the reference numeral 120, and the casing frame is indicated by the reference numeral 160.

In the timepiece body 20 of the timepiece 10 of the present embodiment, as is shown in the same figure, it is clear that since no casing frame is present on either side of the movement 60 in the 3 o'clock to 9 o'clock direction, the width L1 can be reduced compared to the width L2 of the timepiece body 120 of the conventional timepiece 100. In concrete terms, in a case where the width L2 of the conventional timepiece 100 is 13.0 mm, the width L1 of the timepiece 10 of the present embodiment can be set at 11.3 mm even if the same movement 60 is used. Thus, compared to the width of such a conventional timepiece, the width can be reduced by as much as (approximately) 1.7 mm, or in other words, can be reduced by 10% or more.

Accordingly, while the band 30 has conventionally been slender, it has not been possible to realize a slender case (corresponding to the timepiece body 20) that shows a good balance with this band. On the other hand, as a result of the structure, it has become possible to design timepieces of the bracelet type based on a combination of a slender band and case.

Since the first casing frame 90 and second casing frame 95 hold the movement 60 in the plane direction and thickness direction, respectively, the movement 60 can be securely held even in the case of a structure that is separated into a first casing frame 90 and a second casing frame 95, so that the movement 60 can be securely protected against impact forces from the outside of the timepiece.

Since protrusions 92A through 92D of the casing frames 90 and 95 that contact the wall surfaces of the interior-forming case body portions 51A through 51D are disposed on the first casing frame 90 and second casing frame 95 in the vicinity of the movement guide 91, the movement of the casing frames 90 and 95 with respect to the case body 50 can be restricted by the protrusions 92A through 92D in the vicinity of the movement 60, so that looseness of the respective casing frames 90 and 95 can be securely suppressed, thus making it possible to suppress looseness of the movement 60 even more securely.

Even in the case of a structure that is separated into a first casing frame and a second casing frame, since movement rotation stoppers 91A and 95A are provided as parts that stop the rotation of the movement 60, rotation of the movement 60 in the plane direction can be prevented in either a longitudinally oblong compact movement or a circular compact movement, so that a design with a reduced width in the 3 o'clock to 9 o'clock direction can be realized and the movement can be securely held.

Since Embodiment 1 is a structure referred to as a spring casing frame in which the movement is fixed in place using the elasticity of the casing frames, variation in the dimensions of the case body 50, the back cover 70, and the like can be absorbed and the reliability of the holding of the movement can be increased.

Since the casing frame is separated into two parts, the casing frames can be reduced in size compared to a single integrated casing frame. Moreover, the generation of flash during molding is suppressed, manufacture is facilitated, and the dimensional control of parts is made easy. In addition, the casing frames as a whole tend to adhere tightly to the movement 60, so that looseness can be suppressed even further.

In the back cover 70, the back cover fixing part 71 is absent from the 3 o'clock or 9 o'clock side of the back cover 70. Therefore, spring properties are produced in the remaining back cover fixing parts 71, and quality of attachment and detachment of the back cover 70 is improved. In this construction, furthermore, no back cover fixing part 71 is present in the position of the winding stem. The resulting advantage is that there is no need to cut the back cover 70 to provide an outlet for the winding stem.

In the present embodiment, movement can be used either for analogue display timepieces or digital display timepieces.

### Embodiment 2

Next, Embodiment 2 of the present invention will be described with reference to the attached figures. Embodiment 2 is based on the technical concept of Embodiment 1, and is characterized in that the shape of the spring casing frame is simplified. This embodiment will be described with the same reference numerals assigned to functional members that are the same as in Embodiment 1.

FIG. 8 is a local sectional view which shows the timepiece movement holding structure that constitutes Embodiment 2. In FIG. 8, a movement holding structure in the 6 o'clock direction is illustrated as an example. In FIG. 8, a movement guide 191A that contacts the movement fixing part 61A of the movement 60, an external part 192 that protrudes in the form of a flange, and a protrusion 196 that protrudes from the external part 192 are disposed on the first casing frame 190. The protrusion 196 corresponds to the protrusions 92C and 92D shown in Embodiment 1 (see FIG. 4).

As in Embodiment 1 described above, the movement 60 is held inside the case body 50 by the first casing frame 190 and a second casing frame (not shown in the figures) so that this movement 60 does not move in the plane direction.

Furthermore, the movement 60 can be held in the sectional direction by pressing the movement fixing surface 63 of the movement 60 with the back cover fixing part 71 in which the back cover 70 is provided with the external part 192 of the first casing frame 190. This embodiment is characterized by the fact that there is no shock-absorbing hole 94C or contact portion 94A such as in Embodiment 1 (see FIG. 5) on the first casing frame 190, and the movement 60 is held by pressing the external part 192 by means of the back cover 70.

The second casing frame not shown in the figures also has a similar shape, and the movement 60 is held by a structure similar to that used in the 6 o'clock direction. Furthermore, even with such a casing frame structure, a gasket 80 can be installed using the same structure as in Embodiment 1 (see FIG. 5).

Accordingly, as a result of the formation of the shock-absorbing hole 94C in Embodiment 1 (see FIGS. 3 and 4), the injection mold has a slide core system, and it therefore appears that the mold structure would be complicated. In Embodiment 2, however, in addition to the effects of Embodiment 1, the cost can be reduced since an injection mold with a simple vertical open structure may be used for the first casing frame 190 (including the second casing frame not shown in the figures).

### Embodiment 3

Next, Embodiment 3 of the present invention will be described with reference to the attached figures. In comparison with Embodiments 1 and 2, Embodiment 3 is characterized in that the fixing structure for fixing the back cover 70 to the case body 50 is constructed as a screw fixing structure. The first casing frame and second casing frame are the same as in Embodiment 1 (see FIGS. 2 through 6); accordingly, a description of these parts is omitted, and this embodiment is described with the same reference numerals assigned to the same functional members.

FIG. 9 is a local sectional view showing the timepiece movement holding structure of Embodiment 3. FIG. 9 shows the movement holding structure in the 6 o'clock direction as an example that is representative of the present embodiment. In FIG. 9, female screws 56 are formed in the case body 50 from the direction of the back cover.

Four of these female screws 56 are formed in the four corner parts of the case body 50. The back cover 70 has an essentially rectangular shape that is substantially flat (see also FIG. 3). Screw holes 77 are formed in the back cover 70 in positions corresponding to the female screws 56. Furthermore, a gasket groove 76 is formed around the entire circumference along the interior-forming case body portions 51A through 51D on the inside of these screw holes 77, and a gasket 80 shaped as a circle or thin rod in cross section is mounted in this gasket groove 76. The first casing frame 90 and a second casing frame (not shown in the figures) are formed by the same structures as in the Embodiment 1 (see FIGS. 2 through 6).

Furthermore, a gasket-mounting groove may also be formed on the side of the case body 50.

The back cover 70 is threadably fixed to the case body 50 by means of four fixing screws 98. In this case, the first casing frame 90 is pressed in the sectional direction by the inside main surface 72 of the back cover 70, so that the movement 60 is held in place and the gasket 80 is pressed, thus ensuring the waterproof properties of the timepiece.

Accordingly, in Embodiment 3, the back cover 70 can be formed by a substantially flat plate to simplify the structure. Furthermore, since manufacture is facilitated, the cost can be reduced.

Since the back cover 70 and case body 50 are fixed by the threading of screws, the fixing force is high, and even in the case of a compact timepiece body with a reduced width in the 3 o'clock to 9 o'clock direction, the fixing force can be increased and the movement 60 can be held even more securely.

Moreover, since the gasket 80 is mounted in a gasket groove 76 formed in the back cover 70, positional deviation of the gasket in the plane direction tends not to occur, and the waterproof performance therefore can be further enhanced.

In Embodiments 1 through 3, a configuration in which the width in the 3 o'clock to 9 o'clock direction as a second direction (cross direction) was set smaller than the length in the 12 o'clock to 6 o'clock direction as a first direction was described as an example. However, it would also be possible to make the width in the 12 o'clock to 6 o'clock direction smaller than the width in the 3 o'clock to 9 o'clock direction. This can be realized by rotating the structure shown in Embodiments 1 through 3 by 90 degrees. A description is therefore omitted.

The present invention is not limited to the above-described embodiments, and modifications, improvements, and the like are included in the present invention within a scope that makes it possible to achieve the object of the present invention.

For example, in Embodiments 1 and 2, the casing frame is separated into a first casing frame 90 and a second casing frame 95, but it is also possible to integrate the first casing frame 90 and second casing frame 95 by connecting these casing frames in the 3 o'clock direction and 9 o'clock direction.

With this approach, and assuming that the width of the connecting parts between the first casing frame 90 and second casing frame 95 in the 3 o'clock direction and 9 o'clock direction is set at approximately 0.2 mm, injection molding is possible and the width in the 3 o'clock to 9 o'clock direction becomes approximately 0.2 mm wider than in the above-described embodiments. Here, the effects obtained include those whereby the casing frame can be manufactured by a single injection molding, and installation in the timepiece body is facilitated as a result of the integration of these parts.

Furthermore, in regard to the back cover 70 as well, a structure was used in which the back cover fixing part 71 on the back cover 70 was separated in the 3 o'clock direction and 9 o'clock direction. However, it is also possible to use a structure in which the 3 o'clock direction and 9 o'clock direction are connected.

In the case of such a structure, although this is not shown in the figures, a timepiece body 20 in which the width in the 3 o'clock to 9 o'clock direction is not increased can be provided if the end parts of the movement 60 in the 3 o'clock direction and 9 o'clock direction are reduced in thickness by an amount corresponding to the width or height of the back cover fixing part 71 of the back cover 70. Furthermore, this arrangement allows the back cover fixing part 71 to be formed around the entire circumference of the back cover 70, and hence act as a reinforcement of the back cover 70 to prevent deformation. Consequently, the holding of the movement 60 can be accomplished more securely, and this also contributes to an improvement in the waterproof properties.

Accordingly, Embodiments 1 through 3 provide a timepiece movement holding structure and a timepiece that can be endowed, at a low cost, with a longitudinally oblong smart design with a reduced width in the 3 o'clock to 9 o'clock direction.

Furthermore, by constructing a timepiece having a reduced width in the first direction (12 o'clock to 6 o'clock direction) and an increased width in the second direction (3 o'clock to 9 o'clock direction), it is possible to provide the timepiece with a laterally oblong smart design having a reduced width in the 12 o'clock to 6 o'clock direction.

The terms “in front of,” “behind,” “above,” “below,” “perpendicular,” “horizontal,” “slanted,” and other terms used above for indicating directions refer to directions in the drawings used in the description. Therefore, these terms for indicating directions used for description of the present invention should be interpreted in corresponding fashion alongside the drawings used.

The terms “substantially,” “approximately,” “generally,” and other terms for indicating extents in the above description indicate appropriate amounts of deviation that are of such magnitude as they do not ultimately bring about significant changes in the present invention. These terms for indicating extents should be interpreted as including at least about ±5% error, insofar as no significant change is brought about by this deviation.

This application claims priority to Japanese Patent Application Nos. 2005-017925 and 2005-317999. The entire disclosure of Japanese Patent Application No. 2005-017925 and 2005-317999 are hereby incorporated herein by reference.

Only some working examples of the present invention are described above, but it is clear that one skilled in the art may add various modifications to the above working examples according to the above disclosure without exceeding the range of the present invention as defined in the claims. Furthermore, the examples described above are intended only to describe the present invention, and do not limit the range of the present invention as defined by the claims hereinafter or by equivalent claims.

### KEY

10: Timepiece
20: Timepiece body
50: Case body
51A-51D: Case body internal shape parts
60: Movement
70: Back cover
90: First casing frame
95: Second casing frame
71: Back cover fixing part
72: Inside main surface of back cover

What is claimed is:

1. A timepiece, comprising:
a movement having a front face having a time indicating part and a back face opposite to said front face,
a back cover being arranged on a side of said back face,
a first casing frame being arranged on said back face and laterally contacting said movement,
a second casing frame configured on said back face, being apart and separate from said first casing frame, and sandwiching said movement with said first casing frame.

2. The timepiece according to claim 1, wherein
said first casing frame is horseshoe-shaped.

3. The timepiece according to claim 2, wherein
said first casing frame is formed with synthetic resin.

4. The timepiece according to claim 1, wherein
the length of said movement in a cross direction is shorter than the length of said movement in a sandwich direction.

5. The timepiece according to claim 4, further comprising
a case body to which said back cover is attached, said case body housing said movement, said first casing frame, and said second casing frame.

6. The timepiece according to claim 5, wherein
said first casing frame has a first movement rotation stopper preventing rotation of said movement by contacting one edge of said movement in said sandwich direction.

7. The timepiece according to claim 6, wherein
said second casing frame has a second movement rotation stopper preventing rotation of said movement by contacting the other edge of said movement in said cross direction.

8. The timepiece according to claim 5, wherein
said first casing frame has a movement guide preventing said movement from shifting against said first casing frame by contacting an outer surface in said cross direction of said movement.

9. The timepiece according to claim 8, wherein
said case body has a interior-forming case body portion as a inner surface,
said first casing frame has a protrusion configured adjacent to said movement guide, said protrusion preventing said first casing frame from shifting against said case body by contacting said interior-forming case body portion.

10. The timepiece according to claim 5, wherein
said case body has a interior-forming case body portion,
said back cover has a back cover fixing part attaching said back cover to said case body, said back cover fixing part protruding within said body case only at an edge in said cross direction of said back cover.

11. The timepiece according to claim 10, wherein
said back cover fixing part has a back cover fixing projection extending toward said interior-forming case body portion,
said body case has a concave portion into which said back cover fixing projection is inserted.

12. The timepiece according to claim 10, wherein said first casing frame has
a first contact part contacting said back cover, and
a first elastic deforming part elastically pushing said first contact part to said back cover.

13. The timepiece according to claim 12, wherein
said first elastic deforming part has a shock absorbing hole.

14. The timepiece according to claim 13, wherein
said second casing frame has
a second contact part contacting said back cover, and
a second elastic deforming part elastically pushing said second contact part to said back cover.

15. The timepiece according to claim 14, wherein
said first elastic deforming part has a second shock absorbing hole.

16. The timepiece according to claim 5, wherein
said time indicating part has a pointer and a dial.

17. The timepiece according to claim 16, wherein
said sandwich direction is a 12 o'clock-to-6 o'clock direction of said dial.

18. The timepiece according to claim 16, further comprising
a band connected to said body case to be worn on a body.

19. The timepiece according to claim 18, wherein
the length of said case body in said cross direction is shorter than the length of said case in sandwich direction.

20. The timepiece according to claim 19, wherein
said band is configured to be attached to an appendage.
